(19) United States
(12) Patent Application Publication
(10) Pub. No.: US 2020/0172745 A1
(43) Pub. Date: Jun. 4, 2020

(54) AQUEOUS DISPERSION AND AQUEOUS COATING COMPOSITION COMPRISING THE SAME

(71) Applicants: Dow Global Technologies LLC, Midland, MI (US); Rohm and Haas Company, Collegeville, PA (US)

(72) Inventors: Daoshu Lin, Shanghai (CN); Jianming Xu, Shanghai (CN); Qingwei Zhang, Shanghai (CN); James C. Bohling, Lansdale, PA (US); Paul Doll, North Wales, PA (US); Jian Zou, Shanghai (CN); Liu Yang, Shanghai (CN); Gongwei Pu, Shanghai (CN)

(21) Appl. No.: 16/628,062

(22) PCT Filed: Jul. 11, 2017
(86) PCT No.: PCT/CN2017/092468

§ 371 Date: Jan. 2, 2020

(51) Int. Cl. C09D 7/65; C09D 133/06; C09D 125/14; C09D 7/40; C09D 7/20

(52) U.S. Cl. CPC C09D 7/65; C09D 133/062; C09D 7/20; C09D 7/69; C09D 125/14

(57) ABSTRACT

An aqueous dispersion having reduced VOCs and/or odor and an aqueous coating composition comprising the aqueous dispersion.

### FIELD OF THE INVENTION

The present invention relates to an aqueous dispersion and an aqueous coating composition comprising the same.

### INTRODUCTION

Increasingly stringent policies and regulations for the protection of the environment have led to increased demand for protective coatings having a low volatile organic compound (VOCs) content. The requirement of low VOC coatings favors waterborne coatings over solvent-borne coatings, since the solvent would be a source of a large quantity of VOCs. Aqueous coating compositions having low VOCs have potential for reduced odor and toxicity.

Aqueous coating compositions typically comprise acrylic polymer dispersions as binders. Steam stripping is a widely used approach in removing VOCs from polymer dispersions. For example, U.S. Pat. No. 7,745,567 discloses a process for continuously stripping a polymer dispersion with volatile substances by contacting the dispersion with steam. Unfortunately, stream stripping is less efficient in removing volatile aromatic hydrocarbons (VAHs) like ethyl benzene and benzaldehyde than VOCs with lower boiling points. Therefore, there is a need to develop an aqueous dispersion having reduced VOCs, particularly, aromatic VOCS, and/or odor.

### SUMMARY OF THE INVENTION

The present invention provides an aqueous dispersion by a novel combination of acrylic binder particles with specific polymeric adsorbent particles. The aqueous dispersion of the present invention and an aqueous coating composition comprising such aqueous dispersion have low VOCs and/or low odor.

In a first aspect, the present invention is an aqueous dispersion, comprising: (i) acrylic binder particles, and (ii) polymeric adsorbent particles having a D50 particle size of from 1 to 30 microns and a specific surface area of at least 200 m²/g;

wherein the aqueous dispersion has a VOCs level of 800 ppm or less.

In a second aspect, the present invention is an aqueous coating composition comprising the aqueous dispersion of the first aspect, and a pigment.

In a third aspect, the present invention is a method of removing VOCs from an aqueous dispersion of acrylic binder particles. The method comprises:

admixing the aqueous dispersion of acrylic binder particles with polymeric adsorbent particles, thus forming an aqueous dispersion having a VOCs level of 800 ppm or less,

wherein the polymeric adsorbent particles have a D50 particle size of from 1 to 30 microns and a specific surface area of at least 200 m²/g.

### DETAILED DESCRIPTION OF THE INVENTION

“Aqueous dispersion” herein means that particles dispersed in an aqueous medium. By “aqueous medium” herein is meant water and from 0 to 30%, by weight based on the weight of the medium, of water-miscible compound(s) such as, for example, alcohols, glycols, glycol ethers, glycol esters, and the like.

“VOC” refers to any organic compound with a boiling point less than 250° C. at a pressure of 101 kPa.

“Acrylic” in the present invention includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

“Glass transition temperature” or “T_{g}” in the present invention can be measured by various techniques including, for example, differential scanning calorimetry (“DSC”) or calculation by using a Fox equation. The particular values of T_{g} reported herein are those calculated by using the Fox equation (T. G. Fox, Bull. Am. Physics Soc., Volume 1, Issue No. 3, page 123 (1956)). For example, for calculating the T_{g} of a copolymer of monomers M₁ and M₂,

$$\frac{1}{{T}_{g} ( calc . )} = \frac{w ( {M}_{1} )}{{T}_{g} ( {M}_{1} )} + \frac{w ( {M}_{2} )}{{T}_{g} ( {M}_{2} )} ,$$

wherein T_{g}(calc.) is the glass transition temperature calculated for the copolymer, w(M₁) is the weight fraction of monomer M₁ in the copolymer, w(M₂) is the weight fraction of monomer M₂ in the copolymer, T_{g}(M₁) is the glass transition temperature of the homopolymer of monomer M₁, and T_{g}(M₂) is the glass transition temperature of the homopolymer of monomer M₂, all temperatures being in K. The glass transition temperatures of the homopolymers may be found, for example, in “Polymer Handbook”, edited by J. Brandrup and E. H. Immergut, Interscience Publishers.

“Polymerized units”, also known as “structural units”, of the named monomer, refers to the remnant of the monomer after polymerization.

The polymeric adsorbent particle useful in the present invention comprises a porous crosslinked polymer and optionally water. The porous crosslinked polymer useful in the present invention may comprise, as polymerized units, one or more vinyl aromatic monomers and optionally one or more monovinyl aliphatic monomers.

The vinyl aromatic monomer useful in preparing the porous crosslinked polymer may be selected from the group consisting of at least one monovinyl aromatic monomer and at least one polyvinyl aromatic monomer. The vinyl aromatic monomer may be used in an amount of 75% or more, 80% or more, 85% or more, 90% or more, 95% or more, 99% or more, or even 100%, by weight based on the weight of the porous crosslinked polymer (i.e., dry weight of the polymeric adsorbent particle).

The monovinyl aromatic monomers useful in preparing the porous crosslinked polymer may include styrene, α-substituted styrene such as methyl styrene, ethyl styrene, t-butyl styrene, bromo styrene; vinyltoluenes, ethyl vinylbenzenes, vinylnaphthalenes, and heterocyclic monomers such as vinylpyridine, or mixtures thereof. Preferred monovinyl aromatic monomers include styrene and ethyl vinylbenzene, and more preferably styrene. Mixtures of monovinyl aromatic monomers can be employed. The polyvinyl aromatic monomers may include divinylbenzene, trivinyl benzene, divinylnaphthalene, or mixtures thereof; and preferably, divinylbenzene. Mixtures of polyvinylbenzene monomers can be employed. The polyvinyl aromatic monomer is used to crosslink the polymeric adsorbent particles. The vinyl aromatic monomer may comprise 10% or more, 20% or more, 30% or more, 40% or more, 50% or more, 75% or more, 90% or more, or even 100%, of the polyvinyl aromatic monomers; and the rest being the monovinyl aromatic monomers.

The monovinyl aliphatic monomer useful in preparing the porous crosslinked polymer may include esters of (meth)acrylic acids, esters of itaconic acid, esters of maleic acid, and acrylonitrile. Preferred monovinyl aliphatic monomers include methyl methacrylate, acrylonitrile, ethyl acrylate, 2-hydroxyethyl methacrylate and mixtures thereof. The porous crosslinked polymer may comprise as polymerized units, by weight based on the weight of the porous crosslinked polymer, from 0 to 25% of the monovinyl aliphatic monomer, for example, less than 20%, less than 15%, less than 10%, less than 5%, or less than 1% of the monovinyl aliphatic monomer, preferably substantially free of the monovinyl aliphatic monomer.

In some embodiments, the porous crosslinked polymer useful in the present invention comprises as polymerized units, by weight based on the weight of the porous crosslinked polymer, from 0 to 90% of the monovinyl aromatic monomer, from 10% to 100% of the polyvinyl aromatic monomer, and from 0% to 25% of the monovinyl aliphatic monomer. In some further embodiments, the polymeric adsorbent particles comprise a methylene bridged porous crosslinked polymer described above. In one preferred embodiment, the polymeric adsorbent particles useful in the present invention comprise a methylene bridged copolymer of divinylbenzene and a monovinyl aromatic monomer.

The porous crosslinked polymer useful in the present invention may be prepared by free radical polymerization, preferably suspension polymerization. The porous crosslinked polymer may be porogen-modified, that is, prepared by forming a suspension of a monomer mixture within an agitated, continuous suspending medium in the presence of a porogenic solvent or a mixture of such solvent, followed by polymerization of the monomer mixture. The monomer mixture refers to the mixture of the monomers described above as the polymerized units of the porous crosslinked polymer. Porogenic solvents are inert solvents that are suitable for forming pores and/or displacing polymer chains during polymerization. A porogenic solvent is one that dissolves the monomer mixture being polymerized but does not dissolve the polymer obtained therefrom. Examples of such porogenic solvents include aliphatic hydrocarbon compounds such as heptane and octane, aromatic compounds such as benzene, toluene, and xylene, halogenated hydrocarbon compounds such as dichloroethane and chlorobenzene, and linear polymer compounds such as polystyrene. These compounds may be used alone or as a mixture of two or more thereof. Preferred porogenic solvent is toluene. The amount of the porogenic solvent used in the present invention may be from 30 to 300 parts by weight, preferably from 75 to 250 parts by weight, per 100 parts by weight of the monomer mixture for preparing the porous crosslinked polymer.

Suspension polymerization process is well known to those skilled in the art and may comprise suspending droplets of the monomer or monomer mixture and of the porogenic solvent in a medium in which neither are soluble. This may be accomplished by adding the monomer or monomer mixture and the porogenic solvent with any additives to the suspending medium which contains a dispersing or suspending agent. Preferred suspending medium is water. Preferred suspending agent is a suspension stabilizer, for example, gelatin, polyvinyl alcohol or a cellulosic such as hydroxyethyl cellulose, methyl cellulose or carboxymethyl methyl cellulose, or mixtures thereof.

The polymerization process for preparing the polymeric adsorbent particles may be conducted in the presence of a free radical initiator. Examples of the free radical initiators include organic peroxides such as benzoyl peroxide and lauroyl peroxide, organic azo compounds such as azobisisobutyronitrile, or mixtures thereof. The free radical initiator may be used in an amount of from 0.01 to 10 parts by weight per 100 parts by weight of the monomer mixture for preparing the porous crosslinked polymer. Polymerization is typically carried out at temperatures ranging from 15 to 160° C., preferably from 50 to 90° C.

In some embodiments, the porous crosslinked polymer useful in the present invention is subjected to chloromethylation and subsequent post-crosslinking by methylene bridging in a swollen state, as is known to those skilled in the art, for example, in U.S. Pat. Nos. 4,191,813; 4,263,407; 4,950,332; 5,079,274; 5,288,307; 5,773,384; and in U.S. Patent Application Publications 2003/0027879 and 2004/0092899. The obtained polymer is a methylene-bridged aromatic polymer, which refers to porous copolymers of a vinyl aromatic monomer that have been chloromethylated and then post-crosslinked, preferably in the presence of a Friedel-Crafts catalyst. Friedel-Crafts catalysts may include Lewis acids including, for example, AlCl₃, FeCl₃, BF₃ and HF, and preferably AlCl₃ and FeCl₃.

The porous crosslinked polymer obtained from the polymerization process may be isolated by filtration, optionally washed with one or more solvents include tetrahydrofuran, methanol and water. The resultant porous crosslinked polymer may be further dried to obtain beads with a particle size of from 100 to 2000 μm. The particle size of such beads can be determined automatically by using RapidVue Beckman Coulter equipment. The principle of the test method is that the particles passing through the sensor partially block a beam of light focused on a photodiode, producing electrical pulses whose amplitude is proportional to the particle size. These pulses are applied to the counting circuits (channels, bins) within the counter and therefore the particle size is recorded. Examples of commercially available polymeric adsorbent include AMBERLITE™ XAD series, AMBERLITE XE-305,and DOWEX OPTIPORE™ L-493, V-493, V-502, L-285, L-323, V-503, and SD-2 polymeric adsorbents all available from The Dow Chemical Company (AMBERLITE and OPTIPORE are both trademarks of The Dow Chemical Company); LEWATIT VP OC 1064 MD PH, VP OC 1066, VP OC 1163, 60/150 MIBK, and S 6328A polymeric adsorbents all available from Lanxess (formerly Bayer and Sybron); DIAION HP and SP series all available from Mitsubishi Chemical Corporation; PUROSORB AP250 and AP400 polymeric adsorbents both available from Purolite Company; or mixtures thereof.

The porous crosslinked polymer beads can be further subjected to any known particle size reduction means including, for example, crushing, grinding, chopping and milling such as ball milling and ultracentrifugal milling, to give the polymeric adsorbent particles with desirable particle size. Preferably, the polymeric adsorbent particles are employed with powder by dry grinding. Prior to dry grinding, the porous crosslinked polymer beads preferably further dried to achieve a water content as low as possible, for example, 5% by weight or less, or 2% by weight or less of water in the dried polymer beads. The polymeric adsorbent particles useful in the present invention may have a D50 particle size of 0.1 micrometer or larger. The polymeric adsorbent particles may have a D50 particle size of 30 micrometers or smaller, 20 micrometers or smaller, 10 micrometers or smaller, or even 5 micrometers or smaller. When particles have a D50 particle size of a certain value, then 50 percent of the particles by volume is composed of particles having diameter less than or equal to that certain value. The D50 particle size may be measured according to the test method described in the Examples section.

The polymeric adsorbent particles useful in the present invention may have a specific surface area of 200 m²/g or more, 500 m²/g or more, 700 m²/g or more, or even 900 m²/g or more. The polymeric adsorbent particles preferably have a specific surface area of 2,000 m²/g or less, 1,500 m²/g or less, 1300 m²/g or less, or even 1100 m²/g or less. Values of the specific surface area per unit weight of dry polymeric adsorbent particles (m² per gram of the dry polymeric adsorbent particles) were determined by the nitrogen adsorption method in which dried and degassed samples were analyzed on an automatic volumetric sorption analyzer. The instrument works on the principle of measuring the volume of gaseous nitrogen adsorbed by a sample at a given nitrogen partial pressure. The volumes of gas adsorbed at various pressures are used in the BET model for the calculation of the surface area of the sample.

The aqueous dispersion of the present invention further comprises acrylic binder particles, preferably in the form of an aqueous dispersion. The acrylic binder useful in the present invention is typically an emulsion polymer. The binder may be an acrylic binder, a styrene acrylic binder, a vinyl acrylic binder or mixtures thereof.

The acrylic binder useful in the present invention may comprise, as polymerized units, one or more monoethylenically unsaturated nonionic monomers. As used herein, the term “nonionic monomer” means that a monomer does not bear an ionic charge between pH=1-14. Suitable examples of the polymerizable ethylenically unsaturated nonionic monomers include (meth)acrylic ester monomers, i.e., methacrylic ester or acrylic ester monomers including methyl acrylate, ethyl acrylate, butyl acrylate, 2-ethylhexyl acrylate, decyl acrylate, lauryl acrylate, methyl methacrylate, butyl methacrylate, isodecyl methacrylate, and lauryl methacrylate; (meth)acrylonitrile; styrene and substituted styrene such as α-methyl styrene, and vinyl toluene; butadiene; ethylene; propylene; α-olefin such as 1-decene; vinyl esters such as vinyl acetate, vinyl butyrate, and vinyl versatate; and other vinyl monomers such as vinyl chloride and vinylidene chloride. The binder may comprise as polymerized units, based on the dry weight of the binder, from 90% to 100% by weight, from 92% to 99% by weight, or from 94% to 98% by weight, of the monoethylenically unsaturated nonionic monomers.

The acrylic binder useful in the present invention may further comprise, as polymerized units, one or more ethylenically unsaturated monomers having one or more functional groups. The functional groups may be selected from a carbonyl, acetoacetoxy, acetoacetamide, alkoxysilane, ureido, amide, imide, amino, carboxyl, or phosphorous group. Examples of such functional-group-containing ethylenically unsaturated monomer may include α, β-ethylenically unsaturated carboxylic acids including an acid-bearing monomer such as methacrylic acid, acrylic acid, itaconic acid, maleic acid, or fumaric acid; or a monomer bearing an acid-forming group which yields or is subsequently convertible to, such an acid group (such as anhydride, (meth)acrylic anhydride, or maleic anhydride; vinyl phosphonic acid, allyl phosphonic acid, phosphoalkyl (meth)acrylates such as phosphoethyl (meth)acrylate, phosphopropyl (meth)acrylate, phosphobutyl (meth)acrylate, or salts thereof; 2-acrylamido-2-methyl-1-propanesulfonic acid; sodium salt of 2-acrylamido-2-methyl-1-propanesulfonic acid; ammonium salt of 2-acrylamido-2-methyl-1-propane sulfonic acid; sodium vinyl sulfonate; sodium styrene sulfonate; sodium salt of allyl ether sulfonate; and the like; diacetone acrylamide (DAAM), acrylamide, methacrylamide, monosubstituted (meth)acrylamide, N-methylacrylamide, N-ethylacrylamide, N-isopropylacrylamide, N-butylacrylamide, N-tertiary butylacrylamide, N-2-ethylhexylacrylamide, N,N-dimethylacrylamide, N,N-diethylacrylamide, methylacrylamidoethyl ethylene urea, vinyl trimethoxyl silane, 3-Methacryloxypropyltrimethoxysilane, or mixtures thereof. The functional-group-containing ethylenically unsaturated monomer preferably is the ethylenically unsaturated monomer having at least one acetoacetoxy or acetoacetamide functional group. Preferred functional-group-containing ethylenically unsaturated monomer is selected from the group consisting of acrylic acid, methacrylic acid, acrylamide, acetoacetoxyethyl methacrylate (AAEM), phosphoethyl (meth)acrylate, and sodium salt of 2-acrylamido-2-methyl-1-propanesulfonic acid. The binder may comprise as polymerized units, based on the dry weight of the binder, from 0.1% to 20% by weight, from 0.3% to 10% by weight, from 0.5% to 5% by weight, or from 1% to 3% by weight, of such functional-group-containing ethylenically unsaturated monomer.

The acrylic binder useful in the present invention may also comprise, as polymerized units, one or more multiethylenically unsaturated nonionic monomers. Examples of the multiethylenically unsaturated nonionic monomer may include allyl methacrylate, tripropylene glycol dimethacrylate, diethylene glycol dimethacrylate, ethylene glycol dimethacrylate, 1,6-hexanediol dimethacrylate, 1,3-butylene glycol dimethacrylate, polyalkylene glycol dimethacrylate, diallyl phthalate, trimethylolpropane trimethacrylate, divinylbenzene, divinyltoluene, trivinylbenzene, divinylnaphthalene, or mixtures thereof. The binder may comprise as polymerized units, by weight based on the dry weight of the acrylic binder, from 0.01% to 1% or from 0.1% to 0.5%, of the multiethylenically unsaturated nonionic monomer.

The types and levels of the monomers described above for preparing the acrylic binder may be chosen to provide the binder with a glass transition temperature (T_{g}) in the range of from −50° C. to 100° C., from −30° C. to 50 ° C., from −10° C. to 40° C., or from 0° C. to 30° C.

The acrylic binder useful in the present invention may be prepared by emulsion polymerization of the monomers described above. Conditions of emulsion polymerization are known in the art, for example, U.S. Pat. No. 3,399,080 and 3,404,116. Multistage free-radical polymerization can also be used in preparing the acrylic binder, which at least two stages are formed sequentially, and usually results in the formation of the multistage polymer comprising at least two polymer compositions. The polymerization process typically gives an aqueous dispersion of acrylic binder particles. The acrylic binder particles may have an average particle size of from 50 to 500 nanometers (nm), from 80 to 300 nm, from 100 to 200 nm, or from 110 to 180 nm. The average particle size herein refers to the number (D-90) average particle size as measured by Brookhaven BI-90 Particle Size Analyzer.

The aqueous dispersion of acrylic binder particles may employ other low odor technology to lower down the level of VOCs and/or odor by including an acrylic binder comprising as polymerized units the ethylenically unsaturated monomer having at least one acetoacetoxy or acetoacetamide functional group as described above, or including a non-polymeric compound having at least one acetoacetoxy or acetoacetamide functional group with high boiling point organic amine (e.g., boiling point at least 150° C.) as described in US2011/0160368A1. Some carboxylesterase enzyme may also been employed in the aqueous dispersion of acrylic binder particles to further lower down the VOCs and/or odor of organic carboxylester compounds as described in US2012/0083021A1.

The aqueous dispersion of acrylic binder particles obtained from the polymerization process may be further subjected to steam stripping. Process for steam stripping polymer dispersions are known in the art such as those described in U.S. Pat. No. 8,211,987B2 and U.S. Pat. No. 7,745,567B2. The steam stripping can be a continuous process or a batch process. The steam stripping can contact the steam and the aqueous dispersion of acrylic binder particles in one or multiple points. Contacting of the steam and the acrylic binder particles can be in a co-current or counter-current mode for a continuous process. Or the steam may contact the aqueous dispersion of acrylic binder particles in a batch configuration. The batch process typically requires contacting steam from <1 hour up to 6 hours. Both continuous and batch processes are designed to eliminate VOCs in the acrylic binder. Suitable commercially available acrylic binder dispersions may include, for example, PRIMAL™ DC-430V and PRIMAL SF-155, and PRIMAL SF-105 styrene acrylic binders both available from The Dow Chemical Company, ACRONAL 7090 and ACRONAL 506 styrene acrylic binders both available from BASF, or mixtures thereof.

The polymeric adsorbent particles and the acrylic binder particles are mixed to form the aqueous dispersion of the present invention. The polymeric adsorbent particles in the aqueous dispersion may be present, by dry weight based on the dry weight of the acrylic binder particles, in an amount of 0.1% or more, 0.3% or more, 0.6% or more, 0.8% or more, or even 1% or more, and at the same time, 6% or less, 5% or less, 4% or less, 3% or less, or even 2% or less.

The aqueous dispersion of the present invention has low VOCs. “Low VOCs” means that a VOCs content of 800 ppm or less (i.e., 800 μg or less of VOCs per gram of the aqueous dispersion), 700 ppm or less, 600 ppm or less, 400 ppm or less, or even 300 ppm or less. VOCs are measured according to the headspace gas chromatography (GC) test method as described in the Examples section below. The aqueous dispersion of the present invention may also have low odor. “Low odor” means that the aqueous dispersion of the present invention has a lower odor than aqueous dispersions comprising the same acrylic binder particles without the polymeric adsorbent particles.

The aqueous dispersion of the present invention may have a pigment volume concentration (PVC) of less than 15%, less than 10%, or even less than 5%. PVC in the present invention may be determined according to the following equation:

PVC % =[Volume _{(Pigment+Extender+polymeric adsorbent)}/Volume_{(Pigment+Extender+polymeric adsorbent+Acrylic binder)}]×100%

The present invention also relates to a method of removing VOCs and/or odor from an aqueous dispersion of acrylic binder particles, comprising admixing the aqueous dispersion of acrylic binder particles with the polymeric adsorbent particles described above to form the aqueous dispersion of the present invention. The process of removing VOCs and/or odor does not require further removal or filtration of the polymeric adsorbent particles. The addition of the polymeric adsorbent particles into the acrylic binder has no impact on gloss, stain resistance, and/or scrub resistance of paints comprising the polymeric adsorbent particles and the acrylic binder particles. The aqueous dispersion of acrylic binder particles prior to addition of the polymeric adsorbent particles preferably has a VOCs level of 1200 ppm or less. In some embodiments, the aqueous dispersion of acrylic binder particles is subjected to steam stripping prior to admixing with the polymeric adsorbent particles. Steam stripping the aqueous dispersion of acrylic binder particles followed by addition of the polymeric adsorbent particles can increase the VOCs removal efficiency of the polymeric adsorbent particles, particularly the removal efficiency of volatile aromatic hydrocarbons. The method of removing VOCs can give the resultant aqueous dispersion with a VOCs content of 800 ppm or less, 700 ppm or less, 600 ppm or less, 400 ppm or less, or even 300 ppm or less. In some embodiments, the process of removing VOCs results in a VOCs reduction or an aromatic VOCs reduction of at least 15%, at least 20%, at least 25%, or at least 30% as compared to the aqueous dispersion of acrylic binder particles without addition of the polymeric adsorbent particles. Aromatic VOCs herein include benzaldehyde and benzene isomers. The reduced amount of aromatic VOCs can also result in lower odor.

The present invention also relates an aqueous coating composition comprising the aqueous dispersion of the present invention. The aqueous coating composition of the present invention may further comprise pigments to form pigmented coating compositions (also known as “paint formulations”). “Pigment” herein refers to a particulate inorganic material which is capable of materially contributing to the opacity or hiding capability of a coating. Such materials typically have a refractive index greater than 1.8. Inorganic pigments may include, for example, titanium dioxide (TiO₂), zinc oxide, iron oxide, zinc sulfide, barium sulfate, barium carbonate, or mixture thereof. In a preferred embodiment, pigment used in the present invention is TiO₂. TiO₂ typically exists in two crystal forms, anastase and rutile. TiO₂ may be also available in concentrated dispersion form. The aqueous coating composition may also comprise one or more extenders. “Extender” herein refers to a particulate inorganic material having a refractive index of less than or equal to 1.8 and greater than 1.3. Examples of suitable extenders include calcium carbonate, clay, calcium sulfate, aluminosilicates, silicates, zeolites, mica, diatomaceous earth, solid or hollow glass, ceramic beads, nepheline syenite, feldspar, diatomaceous earth, calcined diatomaceous earth, talc (hydrated magnesium silicate), silica, alumina, kaolin, pyrophyllite, perlite, baryte, wollastonite, opaque polymers such as ROPAQUE™ Ultra E available from The Dow Chemical Company (ROPAQUE is a trademark of The Dow Chemical Company), or mixtures thereof. The aqueous coating composition may have a PVC of from 5% to 90%, from 10% to 85%, or from 15% to 80%.

The aqueous coating composition of the present invention may further comprise one or more defoamers. “Defoamers” herein refer to chemical additives that reduce and hinder the formation of foam. Defoamers may be silicone-based defoamers, mineral oil-based defoamers, ethylene oxide/propylene oxide-based defoamers, alkyl polyacrylates, or mixtures thereof. Suitable commercially available defoamers include, for example, TEGO Airex 902 W and TEGO Foamex 1488 polyether siloxane copolymer emulsions both available from TEGO, BYK-024 silicone defoamer available from BYK, or mixtures thereof. The concentration of the defoamer may be, based on the total dry weight of the aqueous coating composition, generally from 0 to 2% by weight, from 0.1% to 1% by weight, or from 0.2% to 0.5% by weight.

The aqueous coating composition of the present invention may further comprise one or more thickeners. The thickeners may include polyvinyl alcohol (PVA), clay materials, acid derivatives, acid copolymers, urethane associate thickeners (UAT), polyether urea polyurethanes (PEUPU), polyether polyurethanes (PEPU), or mixtures thereof. Examples of suitable thickeners include alkali swellable emulsions (ASE) such as sodium or ammonium neutralized acrylic acid polymers; hydrophobically modified alkali swellable emulsions (HASE) such as hydrophobically modified acrylic acid copolymers; associative thickeners such as hydrophobically modified ethoxylated urethanes (HEUR); and cellulosic thickeners such as methyl cellulose ethers, hydroxymethyl cellulose (HMC), hydroxyethyl cellulose (HEC), hydrophobically-modified hydroxy ethyl cellulose (HMHEC), sodium carboxymethyl cellulose (SCMC), sodium carboxymethyl 2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, and 2-hydoxypropyl cellulose. Preferably, the thickener is a hydrophobically-modified hydroxy ethyl cellulose (HMHEC). The concentration of the thickener may be, based on the total dry weight of the aqueous coating composition, generally from 0 to 1% by weight, from 0.1% to 0.8% by weight, or from 0.2% to 0.6% by weight.

The aqueous coating composition of the present invention may further comprise one or more wetting agents. “Wetting agents” herein refer to chemical additives that reduce the surface tension of a coating composition, causing the coating composition to more easily spread across or penetrate the surface of a substrate. Wetting agents may be polycarboxylates, anionic, zwitterionic, or non-ionic. The concentration of the wetting agent may be, based on the total dry weight of the aqueous coating composition, from 0 to 1% by weight, from 0.1% to 0.8% by weight, or from 0.2% to 0.6% by weight.

The aqueous coating composition of the present invention may further comprise one or more coalescents. “Coalescents” herein refer to slow-evaporating solvents that fuse polymer particles into a continuous film under ambient condition. Examples of suitable coalescents include 2-n-butoxyethanol, dipropylene glycol n-butyl ether, propylene glycol n-butyl ether, dipropylene glycol methyl ether, propylene glycol methyl ether, propylene glycol n-propyl ether, diethylene glycol monobutyl ether, ethylene glycol monobutyl ether, ethylene glycol monohexyl ether, triethylene glycol monobutyl ether, dipropylene glycol n-propyl ether, n-butyl ether, or mixtures thereof. Preferred coalescents include dipropylene glycol n-butyl ether, ethylene glycol monobutyl ether, diethylene glycol monobutyl ether, n-butyl ether, or mixtures thereof. The concentration of the coalescent may be, based on the total dry weight of the aqueous coating composition, from 0 to 3% by weight, from 0.1% to 2% by weight, or from 0.2% to 1.5% by weight.

In addition to the components described above, the aqueous coating composition of the present invention may further comprise any one or combination of the following additives: buffers, neutralizers, humectants, mildewcides, biocides, anti-skinning agents, colorants, flowing agents, anti-oxidants, plasticizers, leveling agents, thixotropic agents, adhesion promoters, and grind vehicles. When present, these additives may be present in a combined amount of from 0 to 2% by weight, from 0.1% to 1.5% by weight, or from 0.2% to 1.0% by weight, based on the total weight of the aqueous coating composition.

The aqueous coating composition of the present invention may further comprise water. The concentration of water may be, by weight based on the total weight of the coating composition, from 30% to 90%, from 40% to 80%, or from 50% to 70%.

The aqueous coating composition of the present invention may be prepared by admixing the aqueous polymer dispersion with other optional components, e.g., pigments and/or extenders as described above. When preparing the aqueous coating composition, the polymeric adsorbent particles are first mixed with the acrylic binder particles to form the aqueous polymer dispersion, which then mixes with other components, e.g., pigment. Other components in the aqueous coating composition may be mixed in any order to provide the aqueous coating composition of the present invention. In some embodiments, when the aqueous coating composition comprises pigment and/or extender, the process of preparing the aqueous coating composition of the present invention comprises, (i) forming grinds comprising pigment and/or extender, preferably forming a slurry of pigment and/or extender; (ii) providing the aqueous dispersion of the present invention, and (iii) mixing the grinds and the aqueous dispersion. The process of preparing the aqueous coating composition by using the aqueous dispersion of the present invention (i.e., adding the polymeric adsorbent particles into the acrylic binder particles) surprisingly provides the obtained coating composition with lower VOCs and/or lower odor, as compared to processes where the same polymeric adsorbent particles are added when preparing grinds or after paint preparation.

The aqueous coating composition of the present invention can be applied to, and adhered to, various substrates, comprising applying the aqueous coating composition to a substrate, and drying, or allowing to dry, the applied aqueous coating composition to form a coating. Examples of suitable substrates include wood, metals, plastics, foams, stones, elastomeric substrates, glass, fabrics, concrete, or cementitious substrates. The aqueous coating composition, preferably comprising the pigment, is suitable for various applications such as marine and protective coatings, automotive coatings, traffic paint, Exterior Insulation and Finish Systems (EIFS), roof mastic, wood coatings, coil coatings, plastic coatings, powder coatings, can coatings, architectural coatings, and civil engineering coatings. The coating composition is particularly suitable for architectural coatings.

The aqueous coating composition of the present invention can be applied to a substrate by incumbent means including brushing, dipping, rolling and spraying. The aqueous composition is preferably applied by spraying. The standard spray techniques and equipment for spraying such as air-atomized spray, air spray, airless spray, high volume low pressure spray, and electrostatic spray such as electrostatic bell application, and either manual or automatic methods can be used. After the coating composition of the present invention has been applied to a substrate, the coating composition can dry, or allow to dry, to form a film (this is, coating) at room temperature (20-25° C.), or at an elevated temperature, for example, from 35° C. to 60° C.

### EXAMPLES

Some embodiments of the invention will now be described in the following Examples, wherein all parts and percentages are by weight unless otherwise specified.

The following OPTIPORE and AMBERLITE adsorbents are all available from The

Dow Chemical Company:

DOWEX OPTIPORE L493 adsorbent (“L493”) is a haloalkylated copolymer of styrene and divinylbenzene copolymer (surface area: 1100 m²/g, particle size: 280-900 μm).

DOWEX OPTIPORE SD-2 adsorbent (“SD-2”) is a dimethylamine functionalized alkylene bridged copolymer of styrene and divinylbenzene (surface area: 1100 m²/g, particle size: 280-900 μm).

AMBERLITE XAD4 adsorbent (“XAD4”) is a polymer of divinylbenzene and other vinyl aromatic monomers (surface area: 750 m²/g, particle size: 490-690 μm).

AMBERLITE XAD16N adsorbent (“XAD16N”) is a polymer of divinylbenzene and other vinyl aromatic monomers (surface area: 800 m²/g, particle size: 560-710 μm).

AMBERLITE XAD1600N adsorbent (“XAD1600N”) is a polymer of divinylbenzene and other vinyl aromatic monomers (surface area: 700 m²/g, and particle size: 350-450 μm).

AMBERLITE XAD18 adsorbent (“XAD18”) is a polymer of divinylbenzene and other vinyl aromatic monomers (surface area: 800 m²/g, particle size: 375-475 μm).

AMBERLITE XAD1180 adsorbent (“XAD1180”) is a polymer of divinylbenzene and other vinyl aromatic monomers (surface area: 500 m²/g, particle size: 350-600 μm).

Zeolite is available from Sigma-Aldrich.

Activated carbon, available from Shanghai Activated Carbon Co., Ltd., has an average particle size of 1.5 millimeters (mm).

PRIMAL DC-430V binder (“DC-430V”), available from The Dow Chemical Company, is a waterborne styrene/acrylic binder.

TERGITOL™ 15-S-40, available from The Dow Chemical Company, is a wetting agent (TERGITOL is a trademark of The Dow Chemical Company).

OROTAN™ 731A dispersant, ACRYSOL™ RM-8W thickener (“RM-8W”) and ACRYSOL RM-2020NPR thickener (“RM-2020NPR”) are all available from The Dow Chemical Company (OROTAN and ACRYSOL are trademarks of The Dow Chemical

Company).

NATROSOL 250 HBR thickener (“HBR”) is available from Hercules Incorporated.

AMP-95 base is available from ANGUS Chemie GmbH.

TI-PURE R-996 pigment, available from DuPont, is titanium dioxide pigment.

NOPCO NXZ defoamer is available from SAN NOPCO Ltd.

CELITE 499 pigment is available from IMERYS. Talcum powder (“Talc-800”) and Clay DB-80 are both available from Guangfu Building Materials Group.

The following standard analytical equipment and test methods are used in the Examples.

### BET Method

Specific surface areas of adsorbent particles were determined by nitrogen (N₂) adsorption-desorption isotherms on a Micrometric ASAP 2010 apparatus. Samples were outgassed at 0.13 Pa and 100° C. for 6 hours prior to adsorption studies. The volume of gas adsorbed to the surface of the adsorbent particles was measured at the boiling point of nitrogen (−196° C.). The amount of adsorbed gas was correlated to the total surface area of the adsorbent particles including pores on the surface. Specific surface area calculations were carried out using the BET (Brunauer-Emmett-Teller) method.

### Particle Size (D50)

The D50 particle size of adsorbent particles was measured using a Zetasizer nano ZS (Malvern Instrument, Inc., Worcestershire, UK) at a wavelength of 633 nm with a constant angle of 173° at room temperature. 5 milligrams (mg) of adsorbent particles were dispersed in 1 mL toluene before characterization. The equilibration time was 120 seconds, the cell used for the sample was PCS1115 glass cuvette, measurement duration mode was automatic, and number of measurement was 1. The D50 particle size was obtained via the volume particle size distribution (PSD) page.

### VOCs Measurement

For measuring VOCs of aqueous dispersions comprising adsorbent particles, the adsorbent particles were removed prior to VOCs measurement by centrifugation of aqueous dispersion at 8000 rpm for 10 minutes via an Optima TLX Ultracentrifuge. The obtained samples were then evaluated for VOCs content using a headspace gas chromatography (GC) method. This is a gas chromatographic technique with headspace sampling of a sealed vial containing the sample. Conditions for the headspace GC method were as follows,

GC Instruments: HP5890Plus or HP6890 gas chromatograph and Agilent G1888 headspace auto sampler device;

GC inlet temperature: 180° C.; Mode: split; Split ratio: 13.8:1;

GC-oven program: initial temperature: 45° C. for 5 minutes; heating rate: 20° C./min to 240° C.; hold 5 minutes;

Headspace condition: Oven temperature: 130° C.; loop temperature: 140° C.; transfer line temperature: 150° C.; vial equilibration time: 10 minutes; GC Columns: Rtx-200 (30 m×0.32 mm×1 μm); Carrier gas: Helium; Mode: Pressure constant at 9.28 psi; Flow rate: 2.2 mL/min at 45° C.;

Flame ionization Detector (FID) parameters: 300° C.; Air flow: 400 mL/min; Hydrogen flow: 40 mL/min;

Data System: Data system may range from computerized systems such as Agilent GC ChemStation Rev. B.03.02;

Vials: 20 ml glass headspace vials 23×75 mm (available from Agilent, Inc.; Cat. No. 5182-0837);

Closures: Teflon coated septa (diameter 20 mm) with aluminum crimp-caps;

Preparation of an internal standard solution: Internal standard ethylene glycol diethyl ether (EGDEE) available from Aldrich) was added in DI water to give the concentration of the internal standard solution of 5,000 ppm (C_{IS}, w/w).

Preparation of a standard solution of ethyl benzene and benzaldehyde: calibration curves of ethyl benzene and benzaldehyde, respectively, were developed by a series of solutions with different concentration of ethyl benzene and benzaldehyde in DI water in the internal standard solution (5,000 ppm). The response factors (RFs) of ethyl benzene and benzaldehyde, respectively, were measured using the calibration curve of ethyl benzene and benzaldehyde.

About 10-20 mg of the internal standard solution prepared above was precisely weighed (W_{IS}) in a GC headspace vial, and about 10-20 mg of the sample was also precisely weighed (W_{S}) and then added to the vial. A crimper was used to seal the cap of the vial tightly. Then VOCs of the sample were measured using the headspace GC under conditions described above.

The contents of ethyl benzene and benzaldehyde in the sample were quantified by corresponding response factors of ethyl benzene and benzaldehyde, RF_{ethyl benzene} and RF_{benzaldehyde}, respectively. The contents of other VOCs in the sample were semi-quantified by comparing with the peak area of the internal standard (A_{IS}), and the response factors of other VOCs to the internal standard were considered as ‘1.0’. The content of total VOCs (C_{TVOC}) in the sample were then determined by the sum of concentrations of ethyl benzene, benzaldehyde and other VOCs species. The total content of VOCs in the sample was calculated using equations below:

C_{TVOC}=C_{ethyl benzene}+C_{benzaldehyde}+C_{other VOCs};

wherein, C_{ethyl benzene}=(A_{ethyl benzene}/A_{ethyl benzene})×(W_{IS}/W_{S})×RF_{ethyl benzene}×C_{IS};

C_{benzaldehyde}=(A_{benzaldehyde}/A_{benzaldehyde})×W_{IS}/W_{S}×RF_{benzaldehyde}×C_{IS};

C_{other VOCs}=(A_{other VOCs}/A_{other VOCs})×W_{IS}/W_{S}×C_{IS};

wherein C_{ethyl benzene} is the concentration of ethyl benzene (ppm), C_{benzaldehyde} is the concentration of benzaldehyde (ppm), C_{other VOCs} is the concentration of other VOCs species except ethyl benzene and benzaldehyde (ppm), and C_{IS} is the concentration of internal standard (5000 ppm), A_{ethyl benzene} is the peak area of ethyl benzene, A_{benzaldehyde} is the peak area of benzaldehyde, A_{other VOCs} is the peak area of other VOCs species except ethyl benzene and benzaldehyde, W_{IS} is the weight of internal standard solution (mg), and W_{S} is the weight of sample (mg).

### Odor Evaluation

Odor evaluation was performed according to olfaction sensation. 100 grams (g) of a binder or paint sample was put in a 150 mL plastic bottle, each sample was equilibrated with cap for 1 minute before odor rating. For each sample, seven odor panelists were given “blind” samples of each aqueous binder or paint sample and then smell in can odor. The panelists rated each binder or paint on a scale of 1 to 10, where 1 refers to severe odor, 10 refers to no odor. The higher the score, the less odor.

### Example (Ex) 1

XAD16N adsorbent was dried in an oven at 100° C. for 3 hours before grinding. 15 g of dried XAD16N was added to a planetary ball mill and milled at 4,000 revolutions per minute (rpm) for 60 minutes, to give ground XAD16N adsorbent. 1.5 g of the ground XAD16N adsorbent was added to 100 g of DC-430V binder at 800 rpm for 30 minutes to form an aqueous dispersion for VOCs and odor evaluation.

### Ex 2

XAD4 adsorbent was dried in an oven at 100° C. for 3 hours before grinding. 15 g of dried XAD4 adsorbent was added to a planetary ball mill and milled at 4,000 rpm for 60 minutes, to give ground XAD4 adsorbent. 1.5 g of the ground XAD4 adsorbent was added to 100 g of DC-430V binder at 800 rpm for 30 minutes to form an aqueous for VOCs and odor evaluation.

### Ex 3

XAD1180 adsorbent was dried in an oven at 100° C. oven for 3 hours before grinding. 15 g of dried XAD1180 adsorbent was added to a planetary ball mill and milled at 4000 rpm for 60 minutes, to given ground XAD1180 adsorbent. 1.5 g of the ground XAD1180 adsorbent was added to 100 g of DC-430V binder at 800 rpm for 30 minutes to form an aqueous dispersion for VOCs and odor evaluation.

### Ex 4

XAD1600N adsorbent was dried in an oven at 100° C. for 3 hours before grinding. 15 g of dried XAD1600N was added to a planetary ball mill and milled at 4000 rpm for 60 minutes to give ground XAD1600N adsorbent. 1.5 g of the ground XAD1600N adsorbent was added to 100 g of DC-430V at 800 rpm for 30 minutes to form an aqueous dispersion for VOCs and odor evaluation.

### Ex 5

L493 adsorbent was dried in an oven at 100° C. for 3 hours before grinding. 15 g of dried L493 adsorbent was added to a planetary ball mill and milled at 4000 rpm for 60 minutes, to give ground L493 adsorbent. 1.5 g of the ground L493 adsorbent was added to 100 g of DC-430V binder at 800 rpm for 30 minutes to form an aqueous dispersion for VOCs and odor evaluation.

### Ex 6

SD-2 adsorbent was dried in an oven at 100° C. for 3 hours before grinding. 15 g of dried SD-2 adsorbent was added to a planetary ball mill and milled at 4000 rpm for 60 minutes, to give ground SD-2 adsorbent. 1.5 g of the ground SD-2 adsorbent was added to 100 g of DC-430V binder at 800 rpm for 30 minutes to form an aqueous dispersion for VOCs and odor evaluation.

### Comparative (Comp) Ex A

Zeolite was dried in an oven at 100° C. for 3 hours before grinding. 15 g of dried zeolite was added to a planetary ball mill and milled at 4000 rpm for 60 minutes, to give ground zeolite. 1.5 g of the ground zeolite was added to 100 g of DC-430V binder with stirring at 800 rpm for 30 minutes to form an aqueous dispersion for VOCs and odor evaluation.

### Comp Ex B

Activated carbon was dried in an oven at 100° C. for 3 hours before grinding. 15 g of dried activated carbon was added to a planetary ball mill and milled at 4000 rpm for 60 minutes, to given ground activated carbon. 1.5 g of the ground activated carbon was added to 100 g of DC-430V binder with stirring at 800 rpm for 30 minutes to form an aqueous dispersion for VOCs and odor evaluation.

### Comp Ex C

1.5 g of XAD16N adsorbent (without grinding) was directly added to 100 g of DC-430V binder with stirring at 800 rpm for 1 hour to form an aqueous dispersion for VOCs and odor evaluation.

### Comp Ex D

100 g of DC-430V binder having VOCs of 1,158 ppm was used for VOCs and odor evaluation.

The above obtained aqueous dispersions were evaluated for VOC removal efficiency and results are given in Table 1. As shown in Table 1, the aqueous dispersions of Exs 1-6 contained 3.19% by weight, based on the dry weight of the binder, of ground polymeric adsorbent particles showed much higher VOCs removal efficiency, particularly higher removal efficiency of volatile aromatic hydrocarbons (VAHs), as compared to those comprising ground activated carbon (Comp Ex B) and ground zeolite (Comp Ex A).

TABLE 1
VOCs Removal Efficiency

| | | D50 | | | | | |
|---|---|---|---|---|---|---|---|
| | | Particle | Surface | Remaining | Remaining | Remaining | Remaining |
| Sample | | Size | Area | VOCs | VOCs* | VAHs | VAHs** |
| ID | Adsorbent | (μm) | (m²/g) | (ppm) | (%) | (μg/g) | (%) |
| Ex 1 | ground | 3.3 | 800 | 719 | 60.6 | 26 | 44.1 |
| | XAD16N | | | | | | |
| Ex 2 | ground | 2.8 | 750 | 759 | 64.0 | 27 | 45.8 |
| | XAD4 | | | | | | |
| Ex 3 | ground | 2.9 | 500 | 658 | 55.4 | 26 | 44.1 |
| | XAD1180 | | | | | | |
| Ex 4 | ground | 3.1 | 700 | 666 | 56.1 | 25 | 42.4 |
| | XAD1600N | | | | | | |
| Ex 5 | ground L493 | 2.1 | 1100 | 699 | 58.9 | 25 | 42.4 |
| Ex 6 | ground SD-2 | 4.6 | 1100 | 634 | 53.4 | 25 | 42.4 |
| Comp | ground | 4.9 | 250 | 981 | 82.6 | 51 | 86.4 |
| Ex A | zeolite | | | | | | |
| Comp | ground | | | | | | |
| Ex B | activated | 3.6 | 700 | 933 | 78.6 | 45 | 76.3 |
| | carbon | | | | | | |

*Relative to VOCs of 100 g of DC-430V (without adsorbent treatment)
**Relative to VAHs of 100 g of DC-430V (without adsorbent treatment)

The VOC removal efficiency of ground adsorbents and adsorbents without grinding were also evaluated and results are given in Table 2. As shown in Table 2, the dispersion of Ex 5 comprising the ground L493 adsorbent with 0.5 hour treatment showed higher VOC removal efficiency than the dispersion of Comp Ex C treated by L493 adsorbent without grinding for 1 hour.

TABLE 2
VOCs removal efficiency for different treatment method and time

| | | Adsorbent | Remaining | Remaining | Remaining | Remaining |
|---|---|---|---|---|---|---|
| Sample | | treatment | VOCs | VOCs* | VAHs | VAHs** |
| ID | Adsorbent Type | time¹ | (μ/g) | (%) | (μg/g) | (%) |
| Ex 5 | Ground L493 | 0.5 hour | 699 | 58.9 | 25 | 42.4 |
| | adsorbent | | | | | |
| Comp | L493 adsorbent | 1 hour | 933 | 78.6 | 54 | 91.5 |
| Ex C | (without grinding) | | | | | |

¹Adsorbent treatment time means the mixing time of the adsorbent and the binder before conducting VOCs evaluation.
*Relative to VOCs of 100 g of DC-430V (without adsorbent treatment)
**Relative to VAHs of 100 g of DC-430V (without adsorbent treatment)

The odor of DC-430V binder treated with different types of ground adsorbent resins was also evaluated according to the odor evaluation method described above and results are given in

Table 3. The obtained odor scores for each sample was entered into the SAS JMP 12.2 software. ANOVA (Analysis of Variance) in six sigma methodology was used to analyze significant difference and p-values of each group relative to Comp Ex D are given in Table 3. ANOVA answers the question if the means of several populations are statistically different or equal. A statistical difference is found when the difference between samples is large enough relative to the difference with the control sample. Briefly, if the p-value of two groups is lower than 0.05, these two groups have significant difference. As shown in Table 3, the aqueous dispersions of all inventive examples showed significant odor improvement than those of comparative examples.

TABLE 3
Odor evaluation of DC-430V binder with ground adsorbent resin.

| | | | | p-value |
|---|---|---|---|---|
| | | Odor | Standard | relative to |
| Sample ID | Comments | score | deviation | Comp Ex D |
| Ex 1 | binder with ground | 7.3 | 0.9 | 0.0018 |
| | XAD16N | | | |
| Ex 2 | binder with ground | 7.1 | 0.8 | 0.0039 |
| | XAD4 | | | |
| Ex 3 | binder with ground | 7.4 | 1.3 | 0.0018 |
| | XAD1180 | | | |
| Ex 4 | binder with ground | 7.3 | 1.2 | 0.0018 |
| | XAD1600N | | | |
| Ex 5 | binder with ground | 8.0 | 0.8 | <0.0001 |
| | L493 | | | |
| Ex 6 | binder with ground | 7.0 | 1.3 | 0.0084 |
| | SD-2 | | | |
| Comp | binder with ground | 5.4 | 1.1 | 0.9983 |
| Ex A | zeolite | | | |
| Comp | binder with ground | 4.9 | 1.4 | 1.0000 |
| Ex B | activated carbon | | | |
| Comp | binder without | 5.0 | 0.0 | n/a |
| Ex D | adsorbent | | | |

### Paint Formulations

TABLE 4
Grinds Formulation

| Components | Weight (gram) |
|---|---|
| water | 800 |
| NATROSOL 250 HBR | 8 |
| TERGITOL 15-S-40 | 8 |
| AMP-95 | 0.48 |
| OROTAN 731A | 50 |
| TI-PURE R-996 | 760 |
| CELITE 499 | 100 |
| Clay DB-80 | 480 |
| Talc-800 | 220 |
| water | 40 |
| Grind sub-total | 2466.48 |

### Ex 7

97.5 g of ingredients for preparing grinds were mixed, based on formulations given in Table 4, using a high speed Cowles disperser to form the grinds. Then, 50.75 g of the above aqueous dispersion of Ex 1 comprising ground XAD16N adsorbent and DC-430V binder, 0.3 g of RM-8W thickener, 0.75 g of RM-2020NPR thickener, 0.3 g of NOPCO NXZ defoamer and 0.4 g of DI water were added to the grinds using a conventional lab mixer to obtain a paint formulation.

### Ex 8

97.5 g of ingredients for preparing grinds were mixed, based on formulations given in Table 4, using a high speed Cowles disperser to form the grinds. Then, 50.75 g of the above obtained aqueous dispersion of Ex 2 comprising ground XAD4 adsorbent and DC-430V binder, 0.3 g of RM-8W thickener, 0.75 g of RM-2020NPR thickener, 0.3 g of NOPCO NXZ defoamer, and 0.4 g of DI water were added using a conventional lab mixer to obtain a paint formulation.

### Ex 9

b 97.5 g of ingredients for preparing grinds were mixed, based on formulations given in Table 4, using a high speed Cowles disperser to form the grinds. Then, 50.75 g of the above obtained aqueous dispersion of Ex 3 comprising ground XAD1180 adsorbent and DC-430V binder, 0.3 g of RM-8W thickener, 0.75 g of RM-2020NPR thickener, 0.3 g of NOPCO NXZ defoamer, and 0.4 g of DI water were added to the grinds using a conventional lab mixer to obtain a paint formulation.

### Ex 10

97.5 g of ingredients for preparing grinds were mixed, based on formulations given in Table 4, using a high speed Cowles disperser to form grinds. Then, 50.75 g of the above obtained aqueous dispersion of Ex 4 comprising ground XAD1600N adsorbent and DC-430V binder, 0.3 g of RM-8W thickener, 0.75 g of RM-2020NPR thickener, 0.3 g of NOPCO NXZ defoamer, and 0.4 g of DI water were added to the grinds using a conventional lab mixer to obtain a paint formulation.

### Ex 11

97.5 g of ingredients for preparing grinds were mixed, based on formulations given in Table 4, using a high speed Cowles disperser to form the grinds. Then, 50.75 of the above obtained aqueous dispersion of Ex 5 comprising ground L493 adsorbent and DC-430V binder, 0.3 g RM-8W thickener, 0.75 g RM-2020NPR thickener, 0.3 g NOPCO NXZ defoamer, 0.4 g DI water were added to the grinds using a conventional lab mixer to obtain a paint formulation.

### Ex 12

97.5 g of ingredients for preparing grinds were mixed, based on formulations given in Table 4, using a high speed Cowles disperser to form grinds. Then, 50.75 g of the above obtained aqueous dispersion of Ex 6 comprising ground SD-2 and DC-430V, 0.3 g of RM-8W thickener, 0.75 g of RM-2020NPR thickener, 0.3 g of NOPCO NXZ defoamer, and 0.4 g of DI water were added to the grinds using a conventional lab mixer to obtain a paint formulation.

### Comp Ex E

97.5 g of ingredients for preparing grinds were mixed, based on formulations given in Table 4, using a high speed Cowles disperser to form grinds. Then, 50 g of DC-430V binder, 0.3 g of RM-8W thickener, 0.75 g of RM-2020NPR thickener, 0.3 g of NOPCO NXZ defoamer, and 1.15 g DI water were added to the grinds using a conventional lab mixer to obtain a paint formulation.

### Comp Ex F

97.5 of ingredients for preparing grinds were mixed, based on formulations given in Table 4, using a high speed Cowles disperser to form grinds. Then, 50.75 g of an aqueous dispersion of Comp Ex A comprising ground zeolite and DC-430V binder, 0.3 g of RM-8W thickener, 0.75 g of RM-2020NPR thickener, 0.3 g of NOPCO NXZ defoamer, 0.4 g of DI water were added to the grinds using a conventional lab mixer to obtain a paint formulation.

### Comp Ex G

97.5 g of ingredients for preparing grinds were mixed, based on formulations given in Table 4, using a high speed Cowles disperser to form the grinds. 50.75 g of the above obtained aqueous dispersion of Comp Ex B (comprising ground activated carbon and DC-430V binder), 0.3 g of RM-8W thickener, 0.75 g of RM-2020NPR thickener, 0.3 g of NOPCO NXZ defoamer, and 0.4 g of DI water were added to the grinds using a conventional lab mixer to obtain a paint formulation.

### Comp Ex H

97.5 of ingredients for preparing grinds were mixed, based on formulations given in Table 4, using a high speed Cowles disperser to form grinds. Then, 0.75 g of ground XAD16N adsorbent was added to the grinds using the high speed Cowles and stirring for 30 minutes. Then, 50 g of DC-430V binder, 0.3 g of RM-8W thickener, 0.75 g of RM-2020NPR thickener, 0.3 g of NOPCO NXZ defoamer, 0.4 g of DI water were added using a conventional lab mixer to obtain a paint formulation.

### Comp Ex I

0.75 g of ground XAD16N adsorbent was post added to 150 g of the paint formulation as prepared in Comp Ex E and stirred for 30 minutes.

The as prepared aqueous dispersions of Exs 1-6 and Comp Exs A, B and D were further formulated into paint formulations. Odor of the obtained paints was evaluated according to the odor evaluation method described above and odor results were further analyzed via ANOVA. Odor scores of these paints are given in Table 5. As shown in Table 5, the aqueous dispersion of the present invention all showed odor improvement in paints (Exs 7-12), as compared to paints comprising binders and ground zeolite or ground activated carbon (Comp Exs F and G). Moreover, effects of the addition approach of ground adsorbents on odor of the result paints were also evaluated. As shown in Table 5, the ground XAD-16 adsorbent either added in the grind stage (Comp Ex H) or post added in the paint (Comp Ex I) resulted in stronger odor than the aqueous dispersion of Ex 7 where the ground XAD-6 adsorbent were added in the binder (Ex 7).

TABLE 5
Odor evaluation of paints

| | | | | | p-value |
|---|---|---|---|---|---|
| | | Adsorbent | Odor | Standard | relative to |
| Sample ID | Comments | addition | score | deviation | Comp Ex F |
| Ex 7 | Paint with ground | Mixed with | 7.1 | 0.9 | 0.0008 |
| | XAD16N | binder | | | |
| Ex 8 | Paint with ground | Mixed with | 7.0 | 1.2 | 0.0022 |
| | XAD4 | binder | | | |
| Ex 9 | Paint with ground | Mixed with | 7.0 | 1.0 | 0.0022 |
| | XAD1180 | binder | | | |
| Ex 10 | Paint with ground | Mixed with | 6.7 | 0.8 | 0.0164 |
| | XAD1600N | binder | | | |
| Ex 11 | Paint with ground | Mixed with | 6.9 | 1.1 | 0.0062 |
| | L493 | binder | | | |
| Ex 12 | Paint with ground | Mixed with | 6.9 | 0.4 | 0.0062 |
| | SD-2 | binder | | | |
| Comp | Paint with no | no | 5 | 0 | |
| Ex E | adsorbent | | | | |
| Comp | Paint with ground | Mixed with | 4.3 | 0.8 | 0.8956 |
| Ex F | zeolite | binder | | | |
| Comp | Paint with ground | Mixed with | 5.4 | 1.1 | 0.9972 |
| Ex G | activated carbon | binder | | | |
| Comp | Paint with ground | Added into | 5.1 | 0.9 | 1.0000 |
| Ex H | XAD16N | grind stage | | | |
| Comp | Paint with ground | Post added | 5.9 | 0.7 | 0.7376 |
| Ex I | XAD16N | to paint | | | |

1. An aqueous dispersion, comprising:
(i) acrylic binder particles, and
(ii) polymeric adsorbent particles having a D50 particle size of from 1 to 30 microns and a specific surface area of at least 200 m²/g;
wherein the aqueous dispersion has a VOCs level of 800 ppm or less.

2. The aqueous dispersion of claim 1, wherein the polymeric adsorbent particles are present in an amount of from 0.1% to 6%, by dry weight based on the dry weight of the acrylic binder particles.

3. The aqueous dispersion of claim 1, wherein the polymeric adsorbent particles have a specific surface area of 900 m²/g or more.

4. The aqueous dispersion of claim 1, wherein the polymeric adsorbent particles have a D50 particle size of from 1 to 15 microns.

5. The aqueous dispersion of claim 1 having a VOCs level of 600 ppm or less.

6. The aqueous dispersion of claim 1, wherein the polymeric adsorbent particles comprise a porous crosslinked polymer including as polymerized units, by weight based on the weight of the porous crosslinked polymer, from 0 to 90% of a monovinyl aromatic monomer, from 10% to 100% of a polyvinyl aromatic monomer, and from 0 to 25% of a monovinyl aliphatic monomer.

7. The aqueous dispersion of claim 1 having a PVC of less than 15%.

8. An aqueous coating composition, comprising the aqueous dispersion of claim 1, and a pigment.

9. A process of preparing an aqueous coating composition, comprising
(i) providing the aqueous dispersion of claim 1, and
(ii) mixing the aqueous dispersion with a pigment.

10. A method of removing VOCs from an aqueous dispersion of acrylic binder particles, comprising
admixing the aqueous dispersion of acrylic binder particles with polymeric adsorbent particles, thus forming an aqueous dispersion having a VOCs level of 800 ppm or less,
wherein the polymeric adsorbent particles have a D50 particle size of from 1 to 30 microns and a specific surface area of at least 200 m²/g.)

11. The method of claim 10, wherein the aqueous dispersion of acrylic binder particles has a VOCs level of 1,200 ppm or less prior to admixing with the polymeric adsorbent particles.

12. The method of claim 11, wherein the aqueous dispersion of acrylic binder particles is subjected to steam stripping prior to admixing with the polymeric adsorbent particles.
